(19) United States
(12) Patent Application Publication
(10) Pub. No.: US 2008/0014394 A1
(43) Pub. Date: Jan. 17, 2008

(54) TEXTILE CONSTRUCTION

(76) Inventors: Johann Berger, Alfdorf (DE); Norbert Huber, Bad Sackingen (DE); Jorg Ruschulte, Wehr-Brennet (DE)

Correspondence Address: HARNESS, DICKEY & PIERCE, P.L.C., P.O. BOX 828, BLOOMFIELD HILLS, MI, 48303, US

(21) Appl. No.: 11/835,063

(22) Filed: Aug. 7, 2007

Related U.S. Application Data
(63) Continuation-in-part of application No. 10/397,866, filed on Mar. 26, 2003, now abandoned.

(30) Foreign Application Priority Data
Oct. 5, 2000 (DE) 100 49 395.5
Oct. 5, 2000 (DE) 100 49 395.5-26

(51) Int. Cl. B60R 21/16; B32B 5/02

(52) U.S. Cl. 428/36.1; 442/104; 442/105

(57) ABSTRACT

The disclosure relates to a textile construction for using in passenger restraint systems including air bags, side curtain air bags and air belts. The textile construction is characterized in that it contains plastically deformable filaments which enable the surface of the textile construction to increase when air pressure is applied and to further increase when stuck by an object such as a passenger. The textile construction is also provided with an especially elastic coating.

### CROSS-REFERENCE TO RELATED APPLICATIONS

This application is a continuation-in-part of U.S. patent application Ser. No. 10/397,866 filed on Mar. 26, 2003, which is National Stage of International Application No. PCT/EP2001/011512, filed Oct. 5, 2001, which application claims the benefit of German Application No. 10049395.5, filed Oct. 5, 2000. The disclosures of the above applications is incorporated herein by reference.

### FIELD

The present disclosure relates to a textile sheet fabric for use in passenger restraint systems.

### BACKGROUND

Current air bag systems employ air bags principally harboring the risk of a passenger being catapulted back by the high pressure of the air bag once inflated (rubber ball effect) possibly inflicting serious injury. Hitherto this problem was solved by complicated means in providing vent holes or valves in the side of the air bag facing away from the passenger, or so-called filter fabric having a defined permeability. This results in the air bag collapsing on passenger impact due to the gas therein being exhausted to thus cushion the impact. This arrangement can have drawbacks, however. For one thing, when using filter fabrics having a defined permeability, fluctuations may arise in the absolute permeability to the possible detriment of the gas exhaust of the air bag on impact and to impact hardness. For another, on collapse of the air bag, combustion residues of the air bag inflator may find their way from the air bag vent holes into the vehicle interior where they may result in injuries.

### SUMMARY

The disclosure is based on the objective of providing a textile sheet fabric which avoids, or at least greatly diminishes, the disadvantages of prior art.

This objective is achieved by a textile sheet fabric according to the principles of the present disclosure. Specifically, the textile sheet fabric of the present disclosure is intended for use in passenger restraint systems including air bags, side curtain air bags and air belts. The textile sheet fabric includes plastic deformable threads, which when loaded in at least one sheet direction, permit an increase in the surface of the fabric. The textile sheet fabric is provided with an elastic coating or film of constant, including zero permeability. As used herein, the term “coating” is used to refer to a layer of a substance spread over a surface. The term “film” is used to refer to a thin layer or coating. These terms are used interchangeably throughout this disclosure. Still further, the textile sheet fabric of the present disclosure may have, in at least one thread system, a yarn having a remaining stretch capacity as compared to standard yarns. In other words, the present disclosure provides a textile construction for using in passenger restraint systems wherein the textile construction contains plastically deformable filaments that enable the surface of the textile construction to increase when pressure is applied in at least one surface direction.

The disclosure relates to any kinds of textile sheet fabric, i.e. be it knitted, woven, braided, crocheted or other kind of textile sheet fabric made of yarns or fibers. For the sake of simplicity “fabric” as used in the following is always intended to cover any of these variants.

More recently, air bags are quite generally termed passenger restraint means in vehicle safety systems. Known in addition to this is an air belt as a combination of seat belt and air bag. Since the fabric in accordance with the disclosure is intended for use in both an air bag and air belt, i.e. in all systems having the intention of cushioning passenger impact with a bag or bag-like item, the term “fabric” should not be limited solely to an air bag fabric, but should be interpreted broadly to encompass a fabric used in any air bag-like item used in passenger restraint systems.

Because of its chemistry, structure, definition and elongation properties, the fabric in accordance with the disclosure has many advantages as compared to known air bag fabrics.

Thus, making use of plastic deformable threads, i.e. threads having a remaining stretch capacity in thus becoming longer under load, makes it possible to increase the surface of the fabric in accordance with the disclosure when subjected to impact (e.g. passenger impact). The threads of the fabric instantly stretch and thus become longer without tearing. When an air bag made of a fabric in accordance with the disclosure experiences the impact of a passenger its volume is increased due to the stretch of the fabric. This results in the pressure in the air bag being reduced, it becoming softer, with a likewise reduction in the fiber diameter (titre reduction). This in turn results in the texture of the fabric opening up, i.e. microholes materialize, causing the surface to become correspondingly larger. Structuring the fabric in this way is with no regard to its permeability which is of a major advantage as regards the precision needed in fabrication. The required uniform permeability is achieved by coating the air bag fabric in accordance with the disclosure. This coating is selected so that it continues to maintain the permeability constant in the necessary range even at full stretch (due to the surface increase).

Another advantage of this technique is that in the production phase of the air bag fabric, the factor permeability can be more or less ignored, since this is regulated via the coating to be later applied additionally, thus making for a considerable reduction in production costs.

A further advantageous aspect of the air bag fabric in accordance with the disclosure materializes when employing plastic deformable threads or yarns in at least one thread system enabling it to stretch multistage, when required. The first stage in stretching occurs in the inflation phase in which the yarn stretches to the same degree as yarns currently, usually do. A further stage in stretching commences on impact of the passenger. Here, the deformable yarn continues to stretch in the scope of the remaining stretch capacity. It is due to this additional (final) stretch that the aforementioned increase in volume occurs.

In still another advantageous further embodiment of the disclosure, the coating employed is formulated as a highly elastic film or coating. This has the advantage that the film stretches to the same degree as the final stretch of the fabric which when faced with the film retains the necessary permeability whilst being sealed thereby. Using the air bag fabric in accordance with the disclosure in passenger restraint systems makes for yet a further advantage, namely the time needed to inflate the air bag in a crash situation is now possibly shorter than with usual air bag fabrics since no inflation gas can escape during inflation prior to attaining the final shape. Accordingly, the inflation time is now shorter than with fabrics employed hitherto. The air bag provided with a fabric in accordance with the disclosure thus offers faster impact protection than a conventional air bag. This time saving cannot be appreciated enough by the person skilled in the art.

### BRIEF DESCRIPTION OF THE DRAWINGS

The present disclosure will become more fully understood from the detailed description and the accompanying drawings, wherein:

FIG. 1 is a diagrammatic cross sectional view of a fabric in accordance with the disclosure prior to passenger impact;

FIG. 2 is a detail of the fabric in accordance with the disclosure following passenger impact;

FIG. 3 is an exemplary plot of fabric elongation versus time during inflation of an airbag and subsequent impact by a passenger; and

FIG. 4 is an exemplary plot of rest elongation for an exemplary material according to the present disclosure (Enka® Nylon 447HRT) compared to a material (HT 95) used according to prior art.

### DETAILED DESCRIPTION OF THE PREFERRED EMBODIMENTS

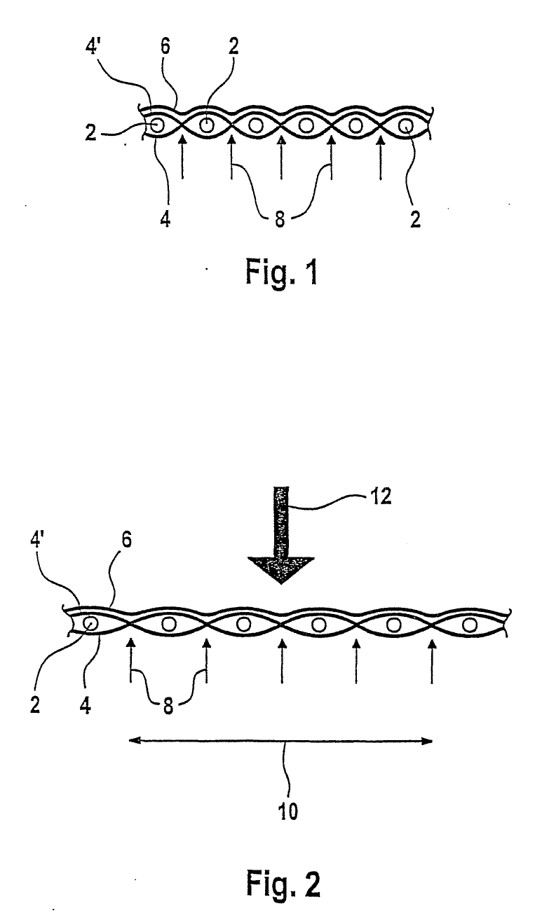

Referring now to FIGS. 1 and 2 there is illustrated a greatly simplified cross section through an air bag fabric according to the present teachings. The air bag can be used in passenger restraint systems including air bags mounted in a steering wheel, dash board or elsewhere in a vehicle. In addition, the air bag may comprise other forms including a side curtain air bag or an air belt for example.

FIG. 1, as viewed in the warp direction, illustrates warp threads 2 symbolized by small circles in the plane of the drawing corresponding to a section through the warp threads 2. Weft threads 4 and 4′, illustrated here for the sake of simplicity as a plain weave, run in the plane of the drawing from left to right in wrapping the warp threads 2 by known ways and means. Applied to the upper surface (as shown in FIG. 1) of the fabric illustrated in this case is a coating or film 6, affixed thereto, for example, by thermal action or by a usual adhesive. The assignment of weft threads 4 and 4′ and warp threads 2 as shown in FIG. 1 corresponds to the condition of the air bag fabric as leaving the weaving machine following coating. The arrows 8 are intended to depict the air flow through the fabric or the permeability thereof, indicating how the air needs to stream between the threads or intersections of the threads in passing through the fabric.

Referring now to FIG. 2 there is illustrated the same fabric as shown in FIG. 1, but here following impact of the passenger symbolized by the arrow 12 pointing downwards. The reaction to the impact of the passenger in the direction of the arrow 12 causes the air bag fabric to stretch in the direction of the double arrow 10 as shown in FIG. 2, indicating how the fabric has changed by the weft threads 4 and 4′ stretching in thus increasing the spacing between the warp threads 2. Comparing the sections of the air bag fabric as shown in FIG. 1 and FIG. 2 demonstrates the surface increase of the fabric as a result of the plastic deformation or stretch of the weft threads 4 and 4′.

What has not changed, however, in the stretched fabric as compared to its unstretched condition is its permeability as indicated here by the arrows 8. The coating 6 is selected so that even with a maximum increase in the surface it still does not allow a change in the value as specified for the permeability of the air bag fabric. According to one example, the air bag fabric can have zero or substantially zero permeability for at least 20 milliseconds upon inflation of the air bag.

The air bag fabric is formed of suitable synthetic threads or yarns having a stretch capacity or plasticity. The synthetic threads or yarns are, for example, a polyamide such as a nylon having suitable properties. One such nylon is marketed under the name Enka® Nylon 447HRT and manufactured by Polyamide High Performance, Inc., of Scottsboro, Ala., USA. The “HRT” suffix identifies favorable characteristics suitable for the instant application, namely heat resistant, stabilized, and tangled (intermingled). This nylon has the following specification reproduced in Tables 1 and 2 below:

TABLE 1

| Linear Density | Number of | Linear | Breaking | Breaking | Elongation | HAS |
|---|---|---|---|---|---|---|
| (nominal) | filaments | density | force | Tenacity | at break | 2 min at |
| dtex | (nominal) | dtex | N | mN/tex | % | 180° C. % |
| 235 | 72 | 236 | 16.8 | 711 | 23.2 | 8.6 |
| 350 | 144 | 351 | 25.1 | 715 | 24.0 | 8.1 |
| 470 | 144 | 474 | 34.0 | 717 | 23.8 | 7.8 |

Tensile testing is performed at a yarn twist of Z60 t/m [symbol]
Low Denier Per Filament

TABLE 2

| | | | Package type | Cylindrical bobbins or [symbol] Cheeses | | | |
|---|---|---|---|---|---|---|---|
| Twisting and Makeup | | | Pallet dimension | 126 × 101 × 108 cm/120 × 100 × 110 cm | | | |
| Linear Density | Number of | | Package | Tube Dimension | Spool | | Pallet Gross |
| (nominal) | filaments | Twist | Weight | L/Ø | Ø | Spool Per | weight (typical) |
| dtex | (nominal) | t/m | kg | mm | mm | pallet | kg |
| 235 | 72 | 0 | 9.5 | 290/94 | 275 | 39 | 405 |
| 350 | 144 | 0 | 9.5 | 290/94 | 275 | 39 | 410 |
| 470 | 144 | 0 | 9.0 | 150/94 | 360 | 48 | 470 |
| 470 | 144 | 0 | 9.1 | 290/94 | 260 | 48 | 485 |
| 470 | 144 | 0 | 9.5 | 290/94 | 275 | 39 | 405 |
| 470 | 144 | 0 | 8.9 | 290/94 | 270 | 39 | 390 |

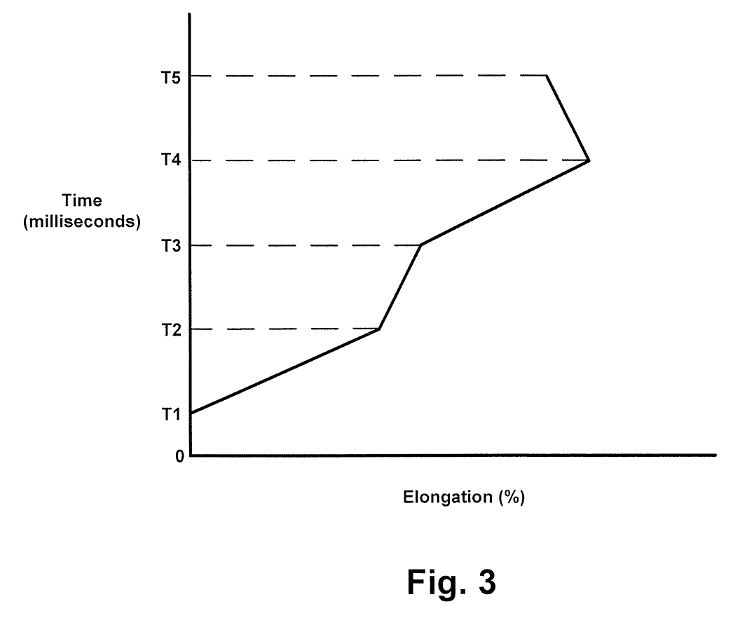

Advantageously, this nylon, upon inflation, will elongate to a predetermined amount less than its maximum. It will then continue to elongate upon impact from a vehicle passenger. Thus, multistage elongation occurs. This behavior is illustrated graphically in FIG. 3. As shown, initial inflation of the air bag occurs from time T1 to time T2. From time T2 to T3 a time delay occurs between initial inflation and passenger impact. From time T3 to T4 passenger impact occurs. From time T4 to T5, the air bag may retract after passenger impact.

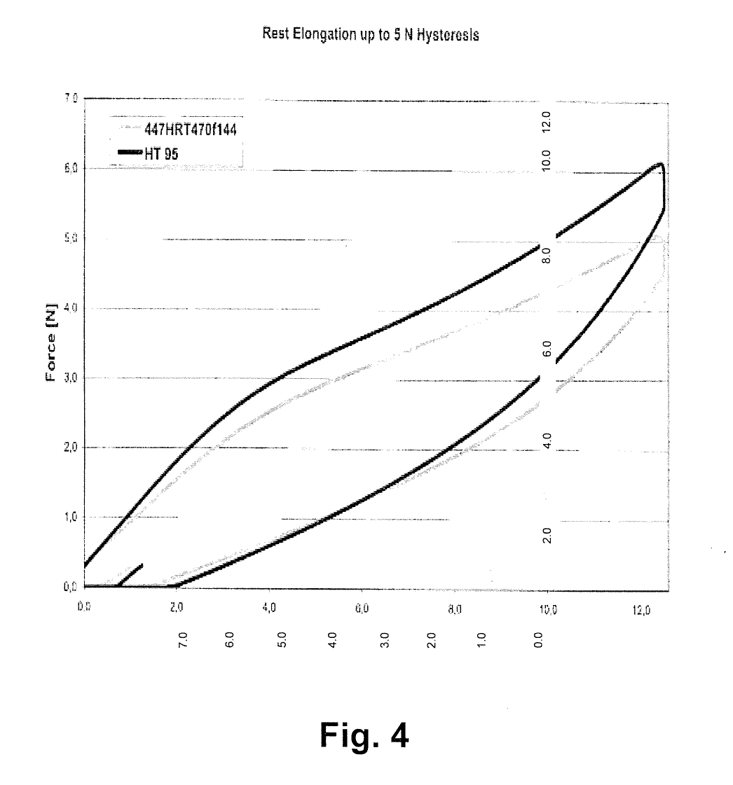

With reference to FIG. 4, Enka® Nylon 447HRT shows a rest elongation of approximately 1.5 mm after release from a load (max. 5N). The rest elongation is a remaining stretch capacity or remaining elongation (before breaking) after an elastic area of the material.

The film 6 may be formed of a liquid silicone rubber. For example, one such liquid silicone product is marketed under the name Elastosil® and manufactured by Wacker Silicones AG, of Munchen, Germany. Suitable liquid silicones are Elastosil® LR 6200 A/B, Elastosil® LR 6250 F, Elastosil® LR 7663, and Elastosil® LR 3162 from Wacker Silicones. The properties of Elastosil® LR 7663, and Elastosil® LR 3162 are reproduced below in Tables 3-5.

TABLE 3
Product data (single components)

| | | | Elastosil ® | |
|---|---|---|---|---|
| Property | Test Method | Unit | LR 7663 | |
| Component | | | A | B |
| Appearance | | | Transparent | Transparent |
| Specific gravity | DIN EN ISO | [g/cm3] | 1.03 | 0.97 |
| | 1183-1 A | | | |
| Viscosity | | [mPa s] | 50,000-80,000 | 20,000-30,000 |
| (Brookfield | | | | |
| viscometer) | | | | |

TABLE 4
Product data (single components) Elastosil ® LR 7663

| Property | Test Method | Unit | Value |
|---|---|---|---|
| Hardness Shore A | DIN 53 505 | | 44 |
| Tensile strength | DIN 53 504 S 1 | [N/mm²] | 4.2 |
| Elongation at break | DIN 53 504 S 1 | [%] | 380 |
| Tear resistance | ASTM D 624 B | [N/mm] | 6.4 |
| Impact resilience | DIN 53 512 | [%] | 56 |
| Dielectric strength, | DIN IEC 243-2 | [kV/mm] | 23 |
| 1 mm sheet | | | |
| Volume resistivity | DIN IEC 93 | [Ω cm] | 5 × 10¹⁵ |
| Dielectric constant (50 Hz) | DIN VDE 0303 | [εᵣ] | 3.1 |
| Dissipation factor (50 Hz) | DIN VDE 0303 | [tan δ] | 30 × 10⁻⁴ |
| Tracking resistance | DIN 53 480 | | KA 3c |

Cure conditions: 5 min/165° C., postcuring: 2 h/200° C.

TABLE 5
Product data

| | | | ELASTOSIL ® |
|---|---|---|---|
| Property | Test Method | Unit | LR3162 |
| Hardness Shore A | DIN 53 505 | | 51 |
| Appearance | | | Black |
| Specific Gravity | DIN 51 562 | [g/cm³] | 1.12 |
| Viscosity | DIN 53 019 | [mPa s] | 7,000,000 |
| (shear rate 0.9 s⁻¹) | | | |
| Tensile strength | DIN 53 504 S1 | [N/MM²] | 5.2 |
| Elongation at break | DIN 53 504 S1 | [%] | 440 |
| Tear resistance | ASTM D 624 B | [N/MM] | 12 |
| Rebound resilience | DIN 53 512 | [%] | 50 |
| Volume resistivity | DIN VDE 0303 | [Ω cm] | 9 |

Measured on sheets vulcanized for 5 min at 165° not post-cured

These silicone products when properly applied in a film thickness of 50 micrometers to a fabric comprising the above described nylon shows an air permeability of zero or substantially zero. Since the silicone coating has an elongation potential in excess of the fabric it provides the fabric with a consistent permeability during inflation of an air bag comprising the described coated fabric.

Further, given the short duration of concern of zero permeability during inflation of the fabric it is only a matter of the thickness of the film 6 of silicone rubber to make it impermeable. Other films or coatings of silicone, polyethylene, or polyurethane may be suitable as the film 6.

The above described fabric of nylon, coated with the above described silicone provides an air bag fabric that will achieve the advantages of providing a stretch capability upon inflation and again upon impact with a vehicle passenger while maintaining a consistent permeability.

The above description is merely exemplary in nature and is not intended to limit the present disclosure, application, or uses. Furthermore, the mixing and matching of features, elements and/or functions between various embodiments is expressly contemplated herein so that one of ordinary skill in the art would appreciate from this disclosure that features, elements and/or functions of one embodiment may be incorporated into another embodiment as appropriate, unless described otherwise above. Moreover, many modifications may be made to adapt a particular situation or material to the teachings of the disclosure without departing from the essential scope thereof. Therefore, it is intended that the disclosure not be limited to the particular embodiment illustrated by the drawings and described in the specification as the best mode presently contemplated for carrying out this disclosure, but that the disclosure will include any embodiments falling within the foregoing description and the appended claims.

What is claimed is:

1. A textile sheet fabric for use in at least one of an airbag and an airbelt, said textile sheet fabric comprising:
warp threads;
weft threads woven with said warp threads to form a surface area,
wherein at least one of the group of said warp threads and said weft threads comprise non-elastomer filaments that elongate when loaded to plastically deform the filaments and produce an increase in said surface area; and
an elastic film disposed upon at least a portion of said surface area, said elastic film having a substantially zero permeability even at full stretch of the fabric, and the coating stretching substantially to the same degree as the final stretch of the fabric.

2. The textile sheet fabric according to claim 1 wherein said at least one of the group of said warp threads and said weft threads are multistage stretch plastic deformable threads for elongating upon inflation and further elongating upon impact of a vehicle passenger.

3. The textile sheet fabric according to claim 1 wherein said elastic film is a highly elastic film or coating.

4. The textile sheet fabric according to claim 1 wherein the airbag is a side curtain airbag.

5. The textile sheet fabric according to claim 1 wherein said at least one of the group of said warp threads and said weft threads are nylon.

6. The textile sheet fabric according to claim 1 wherein said elastic film is silicone.

7. The textile sheet fabric according to claim 1 wherein said at least one of the group of said warp threads and said weft threads elongate when loaded by inflation to a first elongation that is less than 100% of capacity.

8. The textile sheet fabric according to claim 1 wherein said at least one of the group of said warp threads and said weft threads elongate when loaded by inflation to between 10% and 100% of capacity.

9. The textile sheet fabric according to claim 7 wherein said at least one of the group of said warp threads and said weft threads elongate an additional amount greater than said first elongation after impact with an object.

10. An airbag comprising:
a woven textile sheet fabric having warp and weft threads, wherein at least one of the group of said warp and weft threads being plastic deformable threads comprising non-elastomer filaments, said plastic deformable threads adapted to being elongated when loaded in a longitudinal direction and adapted to permit an increase in the surface area of said woven textile sheet fabric, said woven textile sheet fabric having an elastic coating of substantially zero permeability for at least 20 milliseconds upon inflation of the airbag.

11. The airbag according to claim 10 wherein at least one of the group of warp or weft threads stretches in a multistage manner wherein a first stage of said multistage is a result of inflation and a second stage of said multistage is a result of impact.

12. The airbag according to claim 10 wherein said elastic coating is formulated as a highly elastic film or coating having zero gas permeability.

13. The airbag according to claim 10 wherein said at least one of the group of said warp and weft threads is a non-elastomer.

14. The airbag according to claim 10 wherein said at least one of the group of said warp and weft threads is nylon having an elongation potential of substantially between 23% and 25%.

15. The airbag according to claim 10 wherein said elastic coating is a silicone having a elongation potential greater than said at least one of the group of said warp and weft threads.

16. The airbag according to claim 15 wherein said elongation potential of said elastic coating is substantially about 16 times that of said woven textile sheet fabric.

17. A textile sheet fabric for use in a passenger restraint system selected from the group consisting of an airbag, a side curtain airbag, and an airbelt, said textile sheet fabric comprising:
warp threads;
weft threads woven with said warp threads to form a surface area,
wherein at least one of the group of said warp threads and said weft threads being plastic deformable threads, said plastic deformable threads elongating a predetermined amount less than 100% of capacity when inflated and elongating an additional amount when loaded; and
an elastic coating disposed on at least a portion of said surface area, said elastic coating being deformable to an amount greater than said at least one of the group of said warp threads and said weft threads.

18. The textile sheet fabric according to claim 17 wherein said plastic deformable threads are multistage stretch plastic deformable threads.

19. The textile sheet fabric according to claim 17 wherein said elastic coating is a highly elastic film or coating having substantially zero gas permeability.

20. The textile sheet fabric according to claim 17 wherein at least one of the groups of warp or weft threads has a rest elongation of approximately 1.5 mm.

21. The textile sheet fabric according to claim 17 wherein said elastic coating comprises a tensile strength of substantially between about 4.2 and 5.2 N/mm².

22. A woven textile sheet fabric for use in passenger restraint systems, said woven textile sheet fabric comprising:
warp threads;
weft threads woven with said warp threads to form a surface area,
wherein at least one of the group of said warp threads and weft threads having a remaining stretch capacity; and
a coating disposed upon said surface area, said coating having a substantially zero permeability when subjected to stretching in a range of said remaining stretch capacity of said threads.

23. A woven textile sheet fabric according to claim 22, wherein the sheet fabric is adapted to experience an increase of said surface area when subjected to an impact.

24. The woven textile sheet fabric according to claim 22, wherein said coating is an elastic coating.

25. The woven textile sheet fabric according to claim 22, wherein said coating is a liquid silicone rubber.

26. An airbag comprising:
a woven textile sheet fabric having warp threads and weft threads woven with said warp threads to form a surface area, wherein at least one of the group of said warp threads and weft threads defines a stretch capacity; and
a coating disposed upon said surface area, the coating having a substantially zero permeability when subjected to stretching in a range of said stretch capacity of said threads.

27. The airbag of claim 26 wherein said stretch capacity defines a first elongation and a second elongation, said first elongation occurring upon inflation of the airbag, said second elongation elongating beyond said first elongation and occurring upon impact.

28. The airbag of claim 27 wherein said coating is an elastic coating.

29. The airbag of claim 27 wherein said coating is a liquid silicone rubber.

30. The airbag of claim 27 wherein said coating comprises a film having a thickness of substantially about 50 millimeters.

31. The airbag of claim 27 wherein said woven textile sheet fabric has an elongation potential of substantially between 23% and 25%.

32. The airbag of claim 31 wherein said coating has an elongation potential greater than said textile sheet fabric.

33. An airbag comprising:
a woven textile sheet fabric having warp threads and weft threads woven with said warp threads to form a surface area,
wherein at least one of the group of said warp threads and weft threads becoming elongated without tearing when loaded in a longitudinal direction and stretched during inflation, said woven textile sheet fabric having a coating of constant permeability regardless of its stretched condition during inflation, the coating preventing inflation gas from escaping through the fabric during inflation.

34. The airbag according to claim 32, wherein at least one of the groups of warp or weft threads is adapted to be stretched multistage defining a first elongation and a second elongation, said first elongation occurring upon inflation of the airbag, said second elongation elongating beyond said first elongation and occurring upon impact.

35. The airbag according to claim 34 wherein said coating comprises a liquid silicone rubber.

36. The airbag according to claim 35 wherein said coating comprises a film having a thickness of substantially about 50 millimeters.

37. The airbag according to claim 36 wherein said coating comprises a tensile strength of substantially between about 4.2 and 5.2 N/mm².

38. The airbag according to claim 36 wherein at least one of the group of warp or weft threads has a rest elongation of approximately 1.5 mm.
